(19) United States
(12) Patent Application Publication
(10) Pub. No.: US 2007/0223529 A1
(43) Pub. Date: Sep. 27, 2007

(54) Methods and apparatus for estimating bandwidth of a data network

(75) Inventors: Albert Lee, Aliso Viejo, CA (US); Mahadevan Kulathu Iyer, Thane (IN)

Correspondence Address: Albert Lee, 51 Sprucewood, Aliso Viejo, CA, 92656, US

(73) Assignee: IST International, Inc.

(21) Appl. No.: 11/804,932

(22) Filed: May 21, 2007

(30) Foreign Application Priority Data
Nov. 23, 2005 (US) PCT/US05/42745

(51) Int. Cl. H04J 3/22; H04J 3/18

(52) U.S. Cl. 370/468; 370/477

(57) ABSTRACT

An inter-departure time of a pair of TCP segments, or a mean inter-departure time of a block of TCP segments, is determined and an inter-arrival time of a pair of non-duplicate acknowledgments is determined. The bandwidth of a data network may be estimated based at least in part on the inter-arrival time if the inter-arrival time is not less than the inter-departure time or the mean inter-departure time.

### CROSS-REFERENCE TO RELATED APPLICATIONS

This application claims the benefit of U.S. Provisional Patent Application Ser. No. 60/630,916, filed Nov. 24, 2004, the disclosure of which is herein expressly incorporated by reference.

### FIELD OF THE INVENTION

The invention relates, in general, to reliable end-to-end communications and, more particularly, to bandwidth estimation for the Transmission Control Protocol.

### BACKGROUND OF THE INVENTION

Packet-switched data networks are commonly represented as multi-layer protocol stacks. Examples include the 7 layer Open System Interface (OSI) model and the 4 layer Transmission Control Protocol/Internet Protocol (TCP/IP) model. The ordering of the layers in the OSI model from highest to lowest is: (1) the application layer, (2) the presentation layer, (3) the session layer (4) the transport layer, (5) the network layer, (6) the data-link layer, and (7) the physical layer. The ordering of the layers in the TCP/IP model from highest to lowest is: (1) the application layer, (2) the transport layer (usually TCP), (3) the internet layer (usually IP), and (4) the network access layer. While this is the most common model, not all TCP/IP implementations follow this model. Also, while the TCP/IP model does not follow the OSI model, the TCP/IP transport layer may be mapped to the OSI transport layer and the TCP/IP internet layer may be mapped to the OSI network layer.

The transport layer is responsible for fragmenting the data to be transmitted into appropriately sized segments for transmission over the network. TCP is a transport layer protocol. The transport layer may provide reliability and congestion control processes that may be missing from the network layer. The network layer is responsible for routing data packets over the network. IP is a network layer protocol. The data-link layer manages the interfaces and device drivers required to interface with the physical elements of the network. Examples of the data-link layer include the Ethernet protocol and the Radio Link Protocol (RLP). The physical layer is composed of the physical portions of the network. Examples include serial and parallel cables, Ethernet and Token Ring cabling, antennae, and connectors.

In a TCP/IP network, applications programs that need to send data to other computers pass data to the transport layer. At the transport layer, the data is fragmented into appropriately sized segments. These segments are then passed to the network layer where they are packaged into datagrams containing header information necessary to transmit the segments across the network. The network layer then calls upon the lower level protocols (e.g. Ethernet or RLP) to manage the transmission of the data across a particular physical medium. As the datagrams are transmitted from one network to another, they may be fragmented further. At the receiving computer, the process is reversed. The lower level protocols receive the datagrams and pass them to the network layer. The network layer reassembles the datagrams into segments and passes the segments to the transport layer. The transport layer reassembles the segments and passes the data to the application.

IP is limited to providing enough functionality to deliver a datagram from a source to a destination and does not provide a reliable end-to-end connection or flow control. There is no guarantee that a segment passed to a network layer using IP will ever get to its final destination. Segments may be received out of order at the receiver or packets may be dropped due to network or receiver congestion. This unreliability was purposefully built into IP to make it a simple, yet flexible protocol.

TCP uses IP as its basic delivery service. TCP provides the reliability and flow control that is missing from IP. TCP/IP Standard 7 states that “very few assumptions are made as to the reliability of the communication protocols below the TCP layer” and that TCP “assumes it can obtain a simple, potentially unreliable datagram service from the lower level protocols” such as IP. To provide the reliability that is missing from IP, TCP uses the following tools: (1) sequence numbers to monitor the individual bytes of data and reassemble them in order, (2) acknowledgment (ACK) flags to tell if some bytes have been lost in transit, and (3) checksums to validate the contents of the segment (NOTE: IP uses checksums only to validate the contents of the datagram header).

In addition, TCP provides flow control due to the fact that different computers and networks have different capacities, such as processor speed, memory and bandwidth. For example, a web enabled mobile phone will not be able to receive data at the same speed at which a web server may be able to provide it. Therefore, TCP must ensure that the web server provides the data at a rate that is acceptable to the mobile phone. The goal of TCP's flow control system is to prevent data loss due to too high a transfer rate, while at the same time preventing under-utilization of the network resources.

Originally, most TCP flow control mechanisms were focused on the receiving end of the connection, as that was assumed to be the source of any congestion. One example of a receiver-based flow control mechanism is receive window (RWND) sizing. The size of RWND is advertised by a receiver in the ACKs that it transmits to the sender. The size of RWND is based on factors such as the size of the bandwidth and the latency of the virtual circuit.

However, flow control mechanisms based on the receiver do not address problems that may occur with the network. Such problems may be network outages, high traffic loads and overflowing buffers on network routers. A receiver may be operating smoothly, but the network may be dropping packets because the sender is transmitting data at too high a rate for the network to handle. Therefore, sender-based flow control methods were developed. RFC 2581 details TCP's four flow control methods: (1) slow start, (2) congestion avoidance, (3) fast retransmit, and (4) fast recovery. These flow control methods are designed to prevent a sender from overloading the network by adjusting a sender congestion window in response to network congestion.

Almost all of TCP's flow control services indirectly depend on the size of RWND, and therefore the bandwidth and the latency. This is because the optimal value of the congestion window (CWND) during steady state operation is the value of RWND. Using tools such as ping or trace-route, the latency of the network may be estimated. However, estimating the bandwidth is usually a more complicated and computationally intensive process that may inhibit the performance of a TCP session.

Thus, there is a need in the art to for a new method to estimate the bandwidth of a data network during a TCP session.

### BRIEF SUMMARY OF THE INVENTION

A method and apparatus for estimating the bandwidth of a data network during a Transmission Control Protocol (TCP) session are disclosed. In one embodiment, the method includes determining an inter-departure time of a pair of TCP segments and determining an inter-arrival time of a pair of corresponding non-duplicate acknowledgments. The method further includes estimating the bandwidth of the data network based at least in part on the inter-arrival time when the inter-arrival time is not less than the inter-departure time. In another embodiment, the method includes determining a mean inter-departure time of a block of TCP segments, determining an inter-arrival time of a pair of non-duplicate acknowledgments and estimating the bandwidth of the data network based at least in part on the inter-arrival time when the inter-arrival time is not less than the mean inter-departure time.

Other aspects, features, and techniques of the invention will be apparent to one skilled in the relevant art in view of the following detailed description of the invention.

### BRIEF DESCRIPTION OF THE DRAWINGS

FIG. 1 depicts a simplified system diagram of a system wherein one or more aspects of the invention may be performed, according to one or more embodiments;

FIG. 2 is a flow diagram of how the bandwidth of a data network may be estimated, according to one or more embodiments;

FIG. 3 is a flow diagram of how an estimation eligible block of TCP segments may be determined during a TCP session, according to one or more embodiments; and

FIG. 4 is a flow diagram of how the bandwidth of a data network may be estimated, according to one or more embodiments.

### DETAILED DESCRIPTION OF EXEMPLARY EMBODIMENTS

A method and apparatus for estimating bandwidth of a data network is disclosed. In one embodiment, the bandwidth of a data network may be estimated by determining an inter-departure time of a TCP segment and a previous TCP segment, and determining an inter-arrival time of a non-duplicate acknowledgment corresponding to the TCP segment and a previous non-duplicate acknowledgment corresponding to the previous TCP segment. Thereafter, the bandwidth may be estimated based at least in part on the inter-arrival time when the inter-arrival time is not less than the inter-departure time. In certain embodiments, the TCP segment and the previous TCP segment are transmitted only once during a TCP session.

In another embodiment, the inter-departure time may be calculated as the difference between the transmission time of the TCP segment from a network node minus the transmission time of the previous TCP segment from the network node. Similarly, the inter-arrival time may be calculated as the difference of the arrival time of the non-duplicate acknowledgment at the network node minus the arrival time of the previous non-duplicate acknowledgment at the network node.

Alternatively, the inter-departure time may be computed as the difference between the detection time of the TCP segment by a network node minus the detection time of the previous TCP segment by the network node. In turn, the inter-arrival time may be calculated as the difference of the detection time of the non-duplicate acknowledgment by the network node minus the detection time of the previous non-duplicate acknowledgment by the network node.

Another aspect of the invention is to update one or more TCP session parameters based at least in part on the estimated bandwidth from above.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. The terms “network node”, “sender”, “receiver”, and “estimation unit” are understood to include any electronic device that contains a processor, such as a central processing unit.

When implemented in software, the elements of the invention are essentially the code segments to perform the necessary tasks. The code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

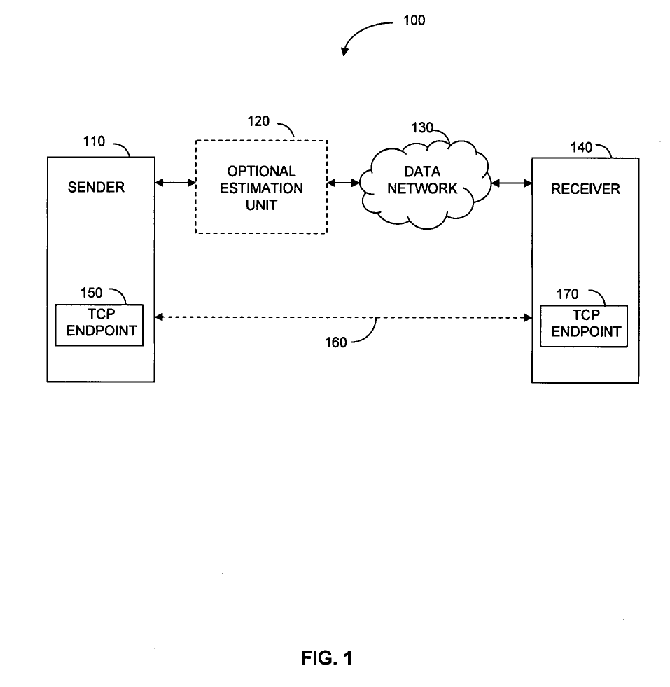

FIG. 1 depicts an exemplary system 100 in which one or more aspects of the invention may be implemented. The system 100 consists of a sender 110 in communication with a receiver 140 over a data network 130. Additionally, system 100 may include an optional estimation unit 120.

Sender 110 may be a network node adapted to create a TCP virtual circuit 160 with another device through the use of one or more TCP modules resident on sender 110. For example, a sender 110 may be a desktop computer, a laptop computer, a cellular telephone, a Personal Digital Assistant (PDA), a server, a network adapter, or an embedded computer. It should be appreciated that the above list is exemplary only, as any device capable of creating a TCP virtual circuit 160 with another device may be considered a sender 110. A TCP module may be part of a Transmission Control Protocol/Internet Protocol (TCP/IP) stack shared by more than one program on sender 110 or it may exist as part of another program. In addition, it should be appreciated that a sender 110 that contains a TCP module consistent with the principles of the invention may further contain other TCP modules that are not so configured.

Receiver 140 may be a network node adapted to create a TCP virtual circuit 160 with another device through the use of one or more TCP modules resident on receiver 140. For example, a receiver 140 may be a desktop computer, a laptop computer, a cellular telephone, a Personal Digital Assistant (PDA), a server, a network adapter, or an embedded computer. It should be appreciated that the above list is exemplary only as any device capable of creating a TCP virtual circuit 160 with another device may be considered a receiver 140. A TCP module may be part of a TCP/IP protocol stack shared by more than one software program on receiver 140 or it may exist as part of another software program. In addition, it should be appreciated that a receiver 140 that contains a TCP module consistent with the principles of the invention may further contain other TCP modules that are not configured as such.

While units 110 and 140 in FIG. 1 have been described as “sender” and “receiver” respectively, it should be appreciated that these terms are arbitrary and that sender 110 may at times be transmitting data to receiver 140, while at other times, receiver 140 may be transmitting data to sender 110.

In the embodiment of FIG. 1, a TCP virtual circuit 160 exists between sender TCP endpoint 150 and receiver TCP endpoint 170. While the details of a TCP virtual circuit are beyond the scope of the present disclosure, they are shown in FIG. 1 to illustrate that reliable TCP sessions, with their attendant flow control algorithms, may be created in sender 110 and receiver 140, even if the underlying network protocols and networks are unreliable. It should be understood that more than one TCP virtual circuit 160 between sender 110 and receiver 140 may exist simultaneously.

The physical connections between the TCP module in sender 110 and the TCP module in receiver 140 may be termed the TCP connection path. They may be wireless or wired physical connections.

Optional estimation unit 120 may be a network node situated in the TCP connection path between sender 110 and receiver 140. It may be a desktop computer, a laptop computer, a network gateway, a network router, a network adapter, or an embedded computer. The above list is exemplary only, as any device or program capable of detecting the transit of a TCP segment through it and reading a TCP header may be an optional estimation unit 120. It should be appreciated that a TCP segment transiting through an optional estimation unit 120 may be fragmented into one or more data-link layer or network layer protocol packets and detecting the transit of a TCP segment may include detecting the transit of one or more of these packets.

While in the embodiment of FIG. 1, optional estimation unit 120 is situated along the TCP connection path between sender 110 and data network 130, it should be appreciated that it may be situated anywhere along the TCP connection path. For example, optional estimation unit 120 may be situated between data network 130 and receiver 140, or it may be situated within data network 130 (e.g. between two physical links in network 130 if network 130 contains more than one physical link). It may also be a network card or electronic circuit in sender 110 or receiver 140.

In certain embodiments optional estimation unit 120 may be adapted to generate data regarding the bandwidth of network 130. Data regarding the bandwidth may include the estimated bandwidth or data from which the estimated bandwidth may be determined.

Optional estimation unit may, in some embodiments, be further configured to transmit data regarding the bandwidth to sender 110 or receiver 140 over the portion of the TCP connection path between it and sender 110 or receiver 140. In these embodiments, transmissions between optional estimation unit 120 and sender 110 or receiver 140 may use TCP, the Universal Datagram Protocol (UDP), or another suitable transport layer protocol. In other embodiments, optional estimation unit 120 may be adapted to transmit data regarding the bandwidth to sender 110 or receiver 140 through a connection existing outside of the TCP connection path. In these embodiments, any suitable protocol may be used (e.g. RS-232, RS-485, TCP, UDP, etc.). Examples of connections outside of the TCP connection path include serial connections, parallel connections, Universal Serial Bus connections, bus connections (e.g. Peripheral Component Interconnect), Local Area Networks (LANs), Wide Area Networks (WANs), and combinations thereof. The connection may be wired or wireless.

Data network 130 may consist of a single network or multiple interconnected networks. Examples of networks that may make up data network 130 include the Internet, LANs, WANs, digital subscriber line (DSL) networks, cable networks, dial-up networks, cellular data networks, and satellite networks. They may be packet-switched networks or circuit-switched networks. The above list of networks that may make up data network 130 is exemplary only and it should be appreciated that any network that may be connected to another network through the use of one or more network layer protocols, such as the Internet Protocol (IP), may be used.

A TCP module in a sender 110 or a receiver 140 may be adapted to estimate the bandwidth of network 130. In certain embodiments, a TCP module in a sender 110 or a receiver 140 may be adapted to receive data regarding the bandwidth from another program on sender 110 or receiver 140 or from optional estimation unit 120 and use this data to determine the estimated bandwidth.

In embodiments where another program in a sender 110 or a receiver 140 may be adapted to generate data regarding the bandwidth, global kernel variables and/or software interrupts may be used to do the inter-process communication between the program and a TCP module residing in sender 110 or receiver 140.

While system 100 has been described in the above embodiments, it should be appreciated that other embodiments are equally valid. It should be further appreciated that FIG. 1 is a simplified representation of a system 100 and, as such, other components may be included in a system 100.

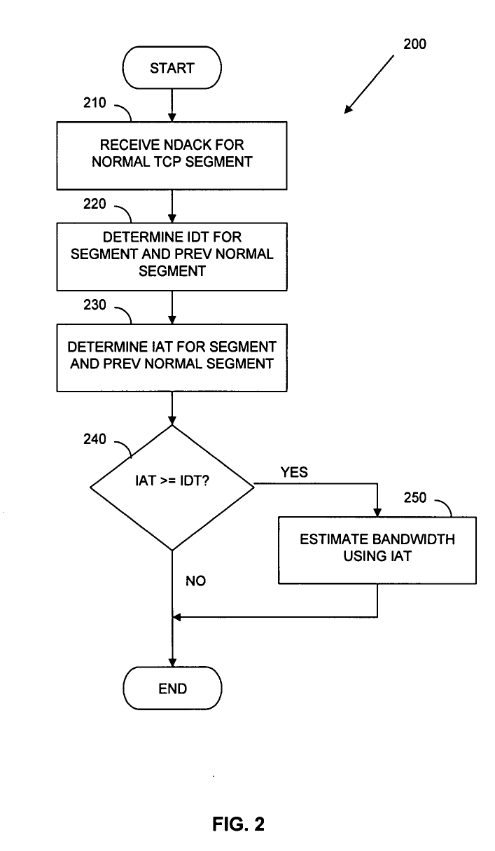

FIG. 2 displays one embodiment of a process 200 to determine the estimated bandwidth of a data network (e.g. data network 130). In certain embodiments, it may be implemented in a TCP module or another program in a network node that may be a sender (e.g. sender 110) or a receiver (e.g. receiver 140). In another embodiment, it may be implemented in a network node that may be an estimation unit (e.g. optional estimation unit 120). It should be appreciated that process 200 may be implemented across more than one network node or program. For example, an estimation unit may perform some of the acts depicted in process 200 while a TCP module or another program in a sender or a receiver may perform the rest.

Process 200 begins at block 210 when a non-duplicate acknowledgement (NDACK) for a normal TCP segment is received at a sender or detected by an estimation module. An NDACK is an acknowledgment (ACK) that has been transmitted by a TCP module in a receiver in response to the receipt of an in-order segment from a sender. A duplicate ACK (DACK), on the other hand, is an ACK sent by a TCP module in a receiver in response to the receipt of an out-of-order segment. For example, if a receiver receives segment 1 before receiving any other segment, it will send out an NDACK for segment 1. If a receiver then receives segment 3 before receiving segment 2, it will send out a DACK. It should be appreciated that an NDACK received by the sender in block 1 may also be a delayed ACK as the term is known in the art. It should be further appreciated that TCP uses negative ACKs. For example, an NDACK corresponding to segment 1 will actually indicate that the TCP module in a receiver is ready to receive segment 2.

A TCP segment may be defined as a normal TCP segment if it is transmitted only once during the TCP session (i.e. it is never retransmitted). If the NDACK in block 210 is not preceded by any DACK associated with the same TCP segment, then the TCP segment associated with the NDACK may be considered a normal TCP segment.

Process 200 proceeds to block 220 where the inter-departure time (IDT) for the normal TCP segment and a previous normal TCP segment (i.e. transmitted before the normal TCP segment) is determined. If process 200 is performed by a TCP module or another program in a sender, then the IDT may be the difference of the transmission time of the normal TCP segment from the sender minus the transmission time of the previous normal TCP segment from the sender. If process 200 is performed by an estimation unit, then the IDT may be the difference of the detection time of the normal TCP segment by the estimation unit minus the detection time of the previous normal TCP segment by the estimation unit. The detection time may be the time at which an estimation unit detects a segment entering or exiting it, or any time in between. An estimation unit may detect a segment by reading the sequence numbers in the TCP headers of the data-link layer or network layer protocol packets transiting through it.

The IDT may be expressed in terms of clock cycles, units of time, or any other suitable timing parameter.

In one embodiment, the IDTs for pairs of normal segments may be calculated as the segments are transmitted from a sender (or transited through an estimation unit). In another embodiment, the IDTs for pairs of segments may be calculated as NDACKs corresponding to the segments are received by a sender (or detected by an estimation unit). In the latter embodiment, the transmission (or detection) times for segments may be stored in temporary variables or arrays to be used as the NDACKs associated with the segments are received by a sender or detected by an estimation unit.

The previous normal TCP segment used in block 220 may be any normal segment transmitted prior to the transmission of the normal TCP segment, as long as any TCP segments transmitted after the transmission of the previous normal TCP segment and prior to the transmission of the normal TCP segment are also normal. Although it is not shown in FIG. 2, it should be appreciated that if the normal TCP segment acknowledged in block 210 is the first normal TCP segment determined since the start of the TCP session or since the last retransmission of a segment during the TCP session, then process 200 may end.

In embodiments where the IDTs for pairs of segments are determined as segments are transmitted from a sender (or detected by an estimation unit), flags or pointers may be used to inform the TCP module or estimation unit that the IDTs for pairs of segments that include at least one segment that is not normal or span one or more segments that are not normal should not be used.

Still referring to FIG. 2, process 200 proceeds to block 230 where the inter-arrival time (IAT) for the normal TCP segment and the previous normal TCP segment is determined. If process 200 is implemented in a TCP module or another program in a sender, the IAT may be the difference between the arrival time of the NDACK corresponding to the normal TCP segment at the sender and the arrival time of the NDACK corresponding to the previous normal TCP segment at the sender.

If process 200 is implemented in an estimation unit, the IAT may be the difference of the detection time of the NDACK corresponding to the normal TCP segment and the detection time of the NDACK corresponding to the previous normal TCP segment. The detection time may be the time at which an estimation module detects an NDACK entering or exiting it, or any time in between. An estimation unit may detect an NDACK corresponding to a TCP segment by reading the acknowledgment numbers in the TCP headers of the data-link layer or network layer protocol packets transiting through it.

The IAT may be expressed in units of time, clock cycles, or any other suitable timing parameter.

Process 200 proceeds to block 240 where a determination of whether the IAT is greater than, or in some embodiments equal to, the IDT is made. If the IAT is less than, or in some embodiments equal to, the IDT, then process 200 ends. Otherwise, process 200 proceeds to block 250.

At block 250 the bandwidth may be estimated based at least in part on the IAT determined in block 230. The bandwidth estimation may be implemented via various methods, such as maintaining a moving average or a moving mode estimate determined during the TCP session. The estimate is recursively updated as follows: when a new IAT sample, iat, is received along with corresponding acknowledgement (via NDACK) of B amount of new data bytes, the estimated bandwidth (bw_estimate) may be updated according to one of the following:
bw_estimate=moving average(bw_estimate,B/iat); or
bw_estimate=moving mode(bw_estimate,B/iat)

The above examples are listed for exemplary purposes and other methods to estimate the bandwidth are equally applicable.

The bandwidth estimated in block 250 may be used to update one or more TCP session parameters in a sender or a receiver. For example, the bandwidth estimated in block 250 may be used to update the congestion window (CWND), the receive window (RWND) and the slow start threshold (SSTHRESH).

While in the embodiment displayed in FIG. 2 the IDT for a pair of normal TCP segments is used, in other embodiments the mean IDT for one or more blocks of TCP segments may be used. A block of TCP segments may be termed an estimation eligible (EE) block. The TCP segments in an EE block do not have to be normal segments as defined previously, however retransmissions of segments are not included. To determine the mean IDT for an EE block, the following parameters may be maintained for the block: (1) the Starting Segment Number (SSN) which is the sequence number of the first segment of the block, (2) the Ending Sequence Number (ESN) which is the sequence number of the last byte of the last segment of the block, (3) the Starting Transmission Time (STT) which is the transmission time of the first segment of the block, and (3) the Ending Transmission Time (ETT) which is the transmission time of the last segment of the block. It should be appreciated that in embodiments where EE blocks are determined by an estimation unit, STT and ETT may refer to the detection times of the first and last segments of the block, respectively.

The parameters SSN, ESN, STT, and ETT for multiple EE blocks may be stored as a linked list or an array of structures.

By maintaining the above four parameters for an EE block, the mean IDT for all pairs of successive segments in the block is effectively maintained and the need to keep all the IDTs for CWND number of TCP segments may be eliminated. The mean IDT for an EE block in certain embodiments may be estimated according to the relation: mean IDT=mean_segment_size*[ETT—STT]/[ESN—SSN+1]. Here mean_segment_size is the estimated average size in bytes of the transmitted TCP segments, and can be implemented as a moving average that is kept updated recursively every time a new TCP segment is transmitted. Usually mean_segment_size will be equal to the maximum segment size (MSS) as the term is known in the art. It should be appreciated that the above relation is for illustrative purposes only and variations of the above relation are applicable to current invention.

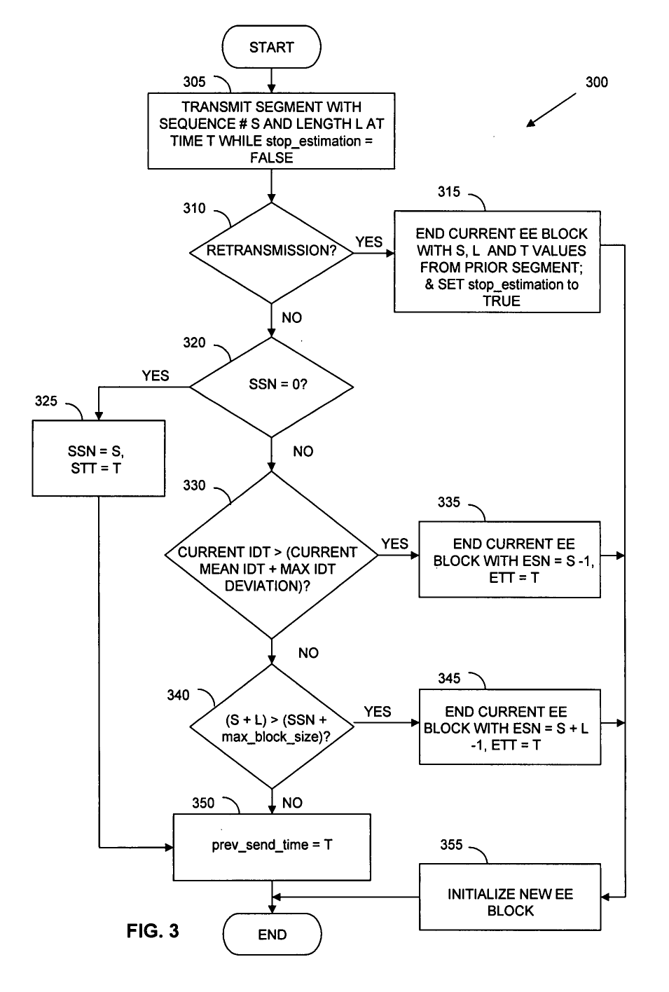

FIG. 3 displays one embodiment of how an EE block may be determined. Process 300 begins at block 305 when a TCP segment with a sequence number S and length L is transmitted from a sender, or detected by an estimation unit, at time T, while the parameter stop_estimation is set to false. The parameter stop_estimation is used to prevent the update or creation of an EE block during TCP's retransmission and recovery phases, such as retransmission upon timeout, fast-retransmit and fast recovery.

Process 300 proceeds to block 310 where it is determined whether the TCP segment transmitted in block 305 is being retransmitted, in which case it is not included in the EE block. In a TCP module or another program in a sender, this determination may be made via various methods, as the TCP module will have made a determination of whether to retransmit a segment before the transmission in block 310. In an estimation unit, the determination may be made in one embodiment by comparing S with the largest observed sequence number in the TCP headers of the packets transiting through the estimation module. If S is less than the largest observed sequence number, then it may be determined that the segment is being retransmitted. In another embodiment, the determination may be made by the detection of a DACK corresponding to the segment.

If the segment is being retransmitted, then process 300 proceeds to block 315 where the current EE block is ended with ESN for the current EE block set to the last byte of the segment transmitted immediately prior to the retransmitted segment and ETT set to the transmission, or detection, time of the prior segment. In addition, stop_estimation is set to TRUE. Process 300 then proceeds to block 355 where a new EE block is initialized.

When a new EE block is initialized at block 355, SSN and one or more of ESN, STT, and ETT for the new block may be set to 0. In addition, memory may be allocated for the SSN, ESN, STT and ETT parameters for that block. Furthermore, the new EE block is marked as the current EE block.

It should be appreciated that upon the start of the TCP connection, the first EE block may be initialized in a similar manner to the initialization of the new EE block performed at block 355. Additionally, the variable prev_recv_time, which is used to determine IAT in another process, may be set to 0 when the first EE block is initialized.

Referring back to block 310, if it is determined that the segment is not being retransmitted, then process 300 proceeds to block 320 where a determination is made of whether SSN of the current EE block is set to zero. If SSN is set to zero, i.e. the segment transmitted in block 305 is the first segment of the current EE block, then process 300 proceeds to block 325 where SSN and STT for the current EE block are set to S and T, respectively. Process 300 may then proceed to from block 325 to block 350 where prev_send_time is set to T.

It should be appreciated that in one embodiment a determination of whether STT is set to zero may be made in block 320 instead of a determination of whether SSN is zero, as an STT set to zero may also indicate that the segment transmitted in block 305 is the first segment of the current EE block.

If, on the other hand, SSN is not zero in block 320, process 300 may proceed to block 330 where the current IDT of the segment transmitted in block 305 is compared to the sum of the current mean IDT of the current EE block plus a maximum IDT deviation (max_IDT_deviation).

The current IDT may be determined as T minus prev_send_time. The value of prev_send_time at this point is the transmission, or detection, time of the last previously transmitted segment of the current EE block.

The current mean IDT may be determined according to the relation: current mean IDT=mean_segment_size*[T−STT]/[S—SSN]. It should be appreciated that the above relation is exemplary and other relations may be used.

In one embodiment, max_IDT_deviation may be a integer (e.g. 1, 2, 3, etc.), while in other embodiments it may be an adjustable parameter. In certain embodiments, max_IDT_deviation may be an integer multiplied by the current mean IDT or an adjustable parameter multiplied by the current mean IDT.

Still referring to FIG. 3, if the current IDT is greater than the sum of the current mean IDT plus max_IDT_deviation, then process 300 proceeds to block 335 where the current EE block is ended with ESN set to S−1 and ETT set to T. Process 300 then proceeds to block 355 where the next EE block is initialized.

If, on the other hand, the current IDT is not greater than the sum of the current mean IDT plus max_IDT_deviation at block 330, then process 300 proceeds to block 340 where the sum of S plus L is compared to the sum of SSN plus the maximum block size (max_block_size) which may be an adjustable parameter. Here L is the length of the current transmitted TCP segment. If the sum of S plus L is greater than, or in some embodiments equal to, the sum of SSN plus max_block_size, then process 300 proceeds to block 345 where the current EE block is ended with ESN set to S+L−1 and ETT set to T.

If, on the other hand, the sum of S plus L is less than, or in some embodiments equal to, the sum of SSN plus max_block_size in block 340, then process 300 proceeds to block 350 where prev_send_time is set to T.

Process 400 displays one embodiment of how the bandwidth may be estimated using the EE blocks determined in process 300. Process 400 begins at block 410 when an NDACK for a normal segment with sequence number S1 is received by a sender, or detected by an estimation module, at time T1. The sequence number may be determined by reading the acknowledgment number in the header field of the NDACK.

Process 400 continues to block 420 where the stop_estimation_flag used in process 300 is set to FALSE. Thereafter, process 400 proceeds to block 430 where a determination of whether prev_recv_time is zero is made. If prev_recv_time is zero, then the NDACK received in block 410 is the first NDACK corresponding to a normal TCP segment received by a sender, or detected by an estimation unit, during the TCP session and process 400 proceeds to block 470 where prev_recv_time is set to the value of T1.

If, on the other hand, prev_recv_time is greater than zero at block 430, then process 400 proceeds to block 440 where the applicable EE block is determined. In one embodiment, the applicable EE block is the one with an SSN less than or equal to S1 and an ESN greater than or equal to S1. It should be noted that the applicable EE block may be the current EE block, in which case SSN will be less than or equal to S1 and ESN will be zero because the current EE block determination has not yet ended.

After the applicable EE block is determined, process 400 proceeds to block 450 where a determination of whether the current IAT is greater than the mean IDT of the applicable EE block is made.

The current IAT may be the value of T1 minus prev_recv_time. The value of prev_recv_time at this point is the arrival time at a sender, or detection time by an estimation unit, of the last previous NDACK corresponding to a previous normal TCP segment.

The mean IDT for the applicable EE block in certain embodiments may be determined according to the relation: mean IDT=mean_segment_size*[ETT—STT]/[ESN—SSN+1]. It should be further appreciated that the values of ETT, STT, ESN, and SSN used in the above relations are the values associated with the applicable EE block determined at block 440. It should be appreciated that the applicable EE block may be the current EE block, it which case the current mean IDT may be used due to the possibility that ETT and ESN may not be determined for the current EE block.

If the current IAT is greater than, or in certain embodiments equal to, the mean IDT of the applicable EE block, process 400 may proceed to block 460 where the bandwidth may be estimated based at least in part on the current IAT and then to block 470 where prev_recv_time is set to T1. The bandwidth estimation may be implemented via various methods, such as maintaining a moving average or a moving-mode estimate determined during the TCP session. The estimate is recursively updated as follows: when a new IAT sample, iat, is received along with corresponding acknowledgment (via NDACK) of B amount of new data bytes, the estimated bandwidth (bw_estimate) may be updated according to one of the following:
bw_estimate=moving_average(bw_estimate,B/iat); or
bw_estimate=moving_mode(bw_estimate,B/iat)

The above examples are listed for exemplary purposes and other methods to estimate the bandwidth are equally applicable.

The bandwidth estimated in block 460 may be used to update one or more TCP session parameters in a sender or a receiver. For example, the bandwidth estimated in block 460 may be used to update CWND, RWND and SSTHRESH.

If, on the other hand, the current IAT is less than, or in certain embodiments equal to, the mean IDT or the current mean IDT of the applicable EE block at block 450, process 400 proceeds to block 470 where prev_recv_time is set to T1.

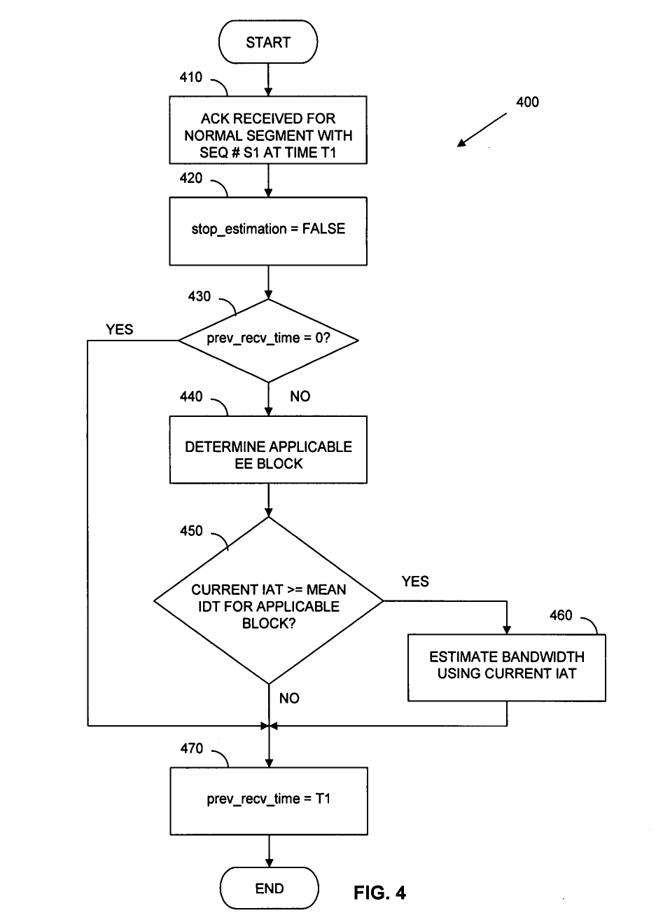

It should be appreciated that the embodiments shown in FIGS. 2-4 are for exemplary purposes only and other embodiments are equally valid. The order of one or more acts depicted in processes 200-400 may be changed while still conforming to the principles of the invention. For the sake of simplicity, processes 200-400 have been defined in general steps and it should be appreciated that other steps consistent with the principles of the invention may be included. Furthermore, although processes 200-400 have been explained as applied to a sender, it should be appreciated that the term sender and receiver are arbitrary and only refer to which network nodes are sending and receiving at a particular point in time.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for estimating bandwidth of a data network comprising the acts of:
determining an inter-departure time of a TCP segment and a previous TCP segment;
determining an inter-arrival time of a non-duplicate acknowledgment corresponding to said TCP segment and a previous non-duplicate acknowledgment corresponding to said previous TCP segment; and
estimating the bandwidth based at least in part on said inter-arrival time when said inter-arrival time is not less than said inter-departure time.

2. The method of claim 1 wherein said TCP segment and said previous TCP segment are transmitted only once during a TCP session.

3. The method of claim 1 wherein said inter-departure time is a difference of a transmission time of said TCP segment from a network node minus a transmission time of said previous TCP segment from the network node, and wherein said inter-arrival time is a difference of an arrival time of said non-duplicate acknowledgment at the network node minus an arrival time of said previous non-duplicate acknowledgment at the network node.

4. The method of claim 1 wherein said inter-departure time is a difference of a detection time of said TCP segment by a network node minus a detection time of said previous TCP segment by the network node, and wherein said inter-arrival time is a difference of a detection time of said non-duplicate acknowledgment by the network node minus a detection time of said previous non-duplicate acknowledgment by the network node.

5. The method of claim 1 further comprising the act of updating one or more TCP session parameters based at least in part on said bandwidth.

6. A method for estimating bandwidth of a data network comprising the acts of:
determining a mean inter-departure time of an estimation eligible block of TCP segments;
determining an inter-arrival time of a non-duplicate acknowledgment corresponding to a TCP segment and a previous non-duplicate acknowledgment corresponding to a previous TCP segment, wherein said TCP segment is associated with said estimation eligible block; and
estimating the bandwidth based at least in part on said inter-arrival time when said inter-arrival time is not less than said mean inter-departure time.

7. The method of claim 6 wherein said TCP segment and said previous TCP segment are transmitted only once during a TCP session.

8. The method of claim 6 wherein said estimation eligible block is defined by a starting segment number, a starting transmission time, an ending sequence number, and an ending transmission time.

9. The method of claim 8 wherein said starting segment number is a sequence number of a first TCP segment of said block, said starting transmission time is a transmission time of said first TCP segment from a network node, said ending sequence number is a sequence number of a last byte of a last TCP segment of said block, and said ending transmission time is a transmission time of said last TCP segment from said network node.

10. The method of claim 8 wherein said starting segment number is a sequence number of a first TCP segment of said block, said starting transmission time is a detection time of said first TCP segment by a network node, said ending sequence number is a sequence number of a last byte of a last TCP segment of said block, and said ending transmission time is a detection time of said last TCP segment by said network node.

11. The method of claim 8 wherein said mean inter-departure time is based at least in part on a difference of the ending transmission time minus the starting transmission time, the difference being then divided by a difference of the ending sequence number minus the starting segment number, the result being then multiplied by a mean segment size.

12. The method of claim 9 wherein, if the ending sequence number is zero, said mean inter-departure time is based at least in part on a difference of a transmission time from the network node of a latest transmitted segment associated with said estimation eligible block minus the starting transmission time, the difference being then divided by a difference of a sequence number of a last byte of said latest transmitted segment minus the starting segment number.

13. The method of claim 10 wherein, if the ending sequence number is zero, said mean inter-departure time is based at least in part on a difference of a detection time by the network node of a latest transmitted segment associated with said estimation eligible block minus the starting transmission time, the difference being then divided by a difference of a sequence number of a last byte of said latest transmitted segment minus the starting segment number.

14. The method of claim 8 further comprising the acts of:
transmitting a plurality of TCP segments;
setting the starting segment number to a sequence number of a first TCP segment of said plurality of TCP segments; and
setting the starting transmission time to one of a transmission time of said first TCP segment from a network node or a detection time of said first TCP segment by the network node.
taking at least one other action wherein said one other action is selected from a group consisting of:
setting the ending sequence number based at least in part on a sequence number of a next to last TCP segment of said plurality of TCP segments when a last TCP segment of said plurality of TCP segments is a retransmitted segment;
setting the ending sequence number based at least in part on a sequence number of said last TCP segment when a current inter-departure time of said last TCP segment and said next to last TCP segment is greater than a sum of a current mean inter-departure time plus a maximum inter-departure time deviation;
setting the ending sequence number based at least in part on a sum of said sequence number of said last TCP segment plus a length of said last TCP segment when said sum of said sequence number of said last TCP segment plus said length of said last TCP segment is greater than a sum of said starting segment number plus a maximum block size;
setting the ending transmission time to one of a transmission time of said next to last TCP segment from the network node or a detection time of said next to last TCP segment by the network node when said last TCP segment is a retransmitted segment;
setting the ending transmission time to one of a transmission time of said last TCP segment from the network node or a detection time of said last TCP segment by the network node when said current inter-departure time of said last TCP segment and said next to last TCP segment is greater than the sum of the current mean inter-departure time plus the maximum inter-departure time deviation; and
setting the ending transmission time to one of the transmission time of said last TCP segment from the network node or a detection time of last TCP segment by the network node when said sum of said sequence number of said last TCP segment plus said length of said last TCP segment is greater than a sum of said starting segment number plus a maximum block size.

15. The method of claim 6 wherein said inter-arrival time is a difference of an arrival time of said non-duplicate acknowledgment at a network node minus an arrival time of said previous non-duplicate acknowledgment at the network node.

16. The method of claim 6 wherein said inter-arrival time is a difference of a detection time of said non-duplicate acknowledgment by a network node minus a detection time of said previous non-duplicate acknowledgment by the network node.

17. The method of claim 6 further comprising the act of updating one or more TCP session parameters based at least in part on said bandwidth.

18. A network node comprising:
a network interface adapted to provide connectivity to a data network;
a processor coupled to said network interface; and
a memory coupled to said processor, said memory containing processor executable instruction sequences to cause the control center to:
determine an inter-departure time of a TCP segment and a previous TCP segment;
determine an inter-arrival time of a non-duplicate acknowledgment corresponding to said TCP segment and a previous non-duplicate acknowledgment corresponding to said previous TCP segment; and
estimating a bandwidth of said data network based at least in part on said inter-arrival time when said inter-arrival time is not less than said inter-departure time.

19. The network node of claim 18 wherein said TCP segment and said previous TCP segment are transmitted only once during a TCP session.

20. The network node of claim 18 wherein said inter-departure time is a difference of a transmission time of said TCP segment from the network node minus a transmission time of said previous TCP segment from the network node, and wherein said inter-arrival time is a difference of an arrival time of said non-duplicate acknowledgment at the network node minus an arrival time of said previous non-duplicate acknowledgment at the network node.

21. The network node of claim 18 wherein said inter-departure time is a difference of a detection time of said TCP segment by the network node minus a detection time of said previous TCP segment by the network node, and wherein said inter-arrival time is a difference of a detection time of said non-duplicate acknowledgment by the network node minus a detection time of said previous non-duplicate acknowledgment by the network node.

22. The method of claim 18 wherein said memory further contains processor executable instruction sequences to cause the network node to update one or more TCP session parameters based at least in part on said bandwidth.

23. A network node comprising:
a network interface adapted to provide connectivity to a data network;
a processor coupled to said network interface; and
a memory coupled to said processor, said memory containing processor executable instruction sequences to cause the control center to:
determine a mean inter-departure time of an estimation eligible block of TCP segments;
determine an inter-arrival time of a non-duplicate acknowledgment corresponding to a TCP segment and a previous non-duplicate acknowledgment corresponding to a previous TCP segment, wherein said TCP segment is associated with said estimation eligible block; and
estimate a bandwidth of said data network based at least in part on said inter-arrival time when said inter-arrival time is not less than said mean inter-departure time.

24. The network node of claim 23 wherein said TCP segment and said previous TCP segment are transmitted only once during a TCP session.

25. The network node of claim 23 wherein said estimation eligible block is defined by a starting segment number, a starting transmission time, an ending sequence number, and an ending transmission time.

26. The network node of claim 25 wherein said starting segment number is a sequence number of a first TCP segment of said block, said starting transmission time is a transmission time of said first TCP segment from the network node, said ending sequence number is a sequence number of a last byte of a last TCP segment of said block, and said ending transmission time is a transmission time of said last TCP segment from said network node.

27. The network node of claim 25 wherein said starting segment number is a sequence number of a first TCP segment of said block, said starting transmission time is a detection time of said first TCP segment by the network node, said ending sequence number is a sequence number of a last byte of a last TCP segment of said block, and said ending transmission time is a detection time of said last TCP segment by said network node.

28. The network node of claim 25 wherein said mean inter-departure time is based at least in part on a difference of the ending transmission time minus the starting transmission time, the difference being then divided by a difference of the ending sequence number minus the starting segment number, the result being then multiplied by a mean segment size.

29. The network node of claim 26 wherein, if the ending sequence number is zero, said mean inter-departure time is based at least in part on a difference of a transmission time from the network node of a latest transmitted segment associated with said estimation eligible block minus the starting transmission time, the difference being then divided by a difference of a sequence number of a last byte of said last transmitted segment minus the starting segment number.

30. The network node of claim 27 wherein, if the ending sequence number is zero, said mean inter-departure time is based at least in part on a difference of a detection time by the network node of a lastest transmitted segment associated with said estimation eligible block minus the starting transmission time, the difference being then divided by a difference of a sequence number of a last byte of said last transmitted segment minus the starting segment number.

31. The network node of claim 25 wherein said memory further contains processor executable instruction sequences to cause the network node to:
transmit a plurality of TCP segments;
set the starting segment number to a sequence number of a first TCP segment of said plurality of TCP segments; and
set the starting transmission time to one of a transmission time of said first TCP segment from the network node or a detection time of said first TCP segment by the network node.
take at least one other action wherein said one other action is selected from a group consisting of:
set the ending sequence number based at least in part on a sequence number of a next to last TCP segment of said plurality of TCP segments when a last TCP segment of said plurality of TCP segments is a retransmitted segment;
set the ending sequence number based at least in part on a sequence number of said last TCP segment when a current inter-departure time of said last TCP segment and said next to last TCP segment is greater than a sum of a current mean inter-departure time plus a maximum inter-departure time deviation;
set the ending sequence number based at least in part on a sum of said sequence number of said last TCP segment plus a length of said last TCP segment when said sum of said sequence number of said last TCP segment plus said length of said last TCP segment is greater than a sum of said starting segment number plus a maximum block size;
set the ending transmission time to one of a transmission time of said next to last TCP segment from the network node or a detection time of said next to last TCP segment by the network node when said last TCP segment is a retransmitted segment;
set the ending transmission time to one of a transmission time of said last TCP segment from the network node or a detection time of said last TCP segment by the network node when said current inter-departure time of said last TCP segment and said next to last TCP segment is greater than the sum of the current mean inter-departure time plus the maximum inter-departure time deviation; and
set the ending transmission time to one of the transmission time of said last TCP segment from the network node or a detection time of last TCP segment by the network node when said sum of said sequence number of said last TCP segment plus said length of said last TCP segment is greater than a sum of said starting segment number plus a maximum block size.

32. The network node of claim 23 wherein said inter-arrival time is a difference of an arrival time of said non-duplicate acknowledgment at the network node minus an arrival time of said previous non-duplicate acknowledgment at the network node.

33. The network node of claim 23 wherein said inter-arrival time is a difference of a detection time of said non-duplicate acknowledgment by the network node minus a detection time of said previous non-duplicate acknowledgment by the network node.

34. The network node of claim 23 wherein said memory further contains processor executable instruction sequences to cause the network node to update one or more TCP session parameters based at least in part on said bandwidth.
